(19) United States
(12) Patent Application Publication
(10) Pub. No.: US 2026/0255400 A1
(43) Pub. Date: Aug. 27, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventor: Zheng ZHAO, Shanghai (CN)

(21) Appl. No.: 19/647,618

(22) Filed: Apr. 14, 2026

Related U.S. Application Data
(63) Continuation of application No. PCT/CN2024/131096, filed on Nov. 8, 2024.

(51) Int. Cl. H04W 74/0833

(52) U.S. Cl. CPC H04W 74/0833

(57) ABSTRACT

A wireless communication method, a terminal device, and a network device are provided. One example method includes: receiving, by a terminal device, first information from a network device, wherein the first information comprises one or more physical random access channel (PRACH) configurations.

### CROSS-REFERENCE TO RELATED APPLICATIONS

This application is a continuation of International Application No. PCT/CN2024/131096, filed on November 08, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

A random access procedure is a process between a step in which a terminal device starts to attempt to access a network by transmitting a random access preamble by using a physical random access channel (physical random access channel, PRACH) and a step in which the terminal device establishes a basic signaling connection to the network. This process is a key step of establishing an initial communication connection between the terminal device and the network. Therefore, how to improve PRACH transmission performance becomes a problem that needs to be resolved.

### SUMMARY

The present application provides a wireless communication method, a terminal device, and a network device. Various aspects of the present application are described below.

According to a first aspect, a wireless communication method is provided, including: receiving, by a terminal device, first information transmitted by a network device, where the first information includes one or more physical random access channel PRACH configurations.

According to a second aspect, a wireless communication method is provided, including: transmitting, by a network device, first information to a terminal device, where the first information includes one or more physical random access channel PRACH configurations.

According to a third aspect, a terminal device is provided, including: a transceiver unit, receiving first information transmitted by a network device, where the first information includes one or more physical random access channel PRACH configurations.

According to a fourth aspect, a network device is provided, including: a transceiver unit, transmitting first information to a terminal device, where the first information includes one or more physical random access channel PRACH configurations.

According to a fifth aspect, a terminal device is provided, including a transceiver, a memory, and a processor, where the memory is configured to store a program, and the processor is configured to: invoke the program in the memory, and control the transceiver to receive or transmit a signal, to cause the terminal device to execute the method according to the first aspect.

According to a sixth aspect, a network device is provided, including a transceiver, a memory, and a processor, where the memory is configured to store a program, and the processor is configured to: invoke the program in the memory, and control the transceiver to receive or transmit a signal, to cause the network device to execute the method according to the second aspect.

According to a seventh aspect, an apparatus is provided, including a processor configured to invoke a program from a memory, to cause the apparatus to execute the method according to the first aspect or the second aspect.

According to an eighth aspect, a chip is provided, including a processor configured to invoke a program from a memory, to cause a device on which the chip is installed to execute the method according to the first aspect or the second aspect.

According to a ninth aspect, a computer-readable storage medium is provided, where the computer-readable storage medium stores a program, and the program causes a computer to execute the method according to the first aspect or the second aspect.

According to a tenth aspect, a computer program product is provided, where the computer program product includes a program, and the program causes a computer to execute the method according to the first aspect or the second aspect.

According to an eleventh aspect, a computer program is provided, where the computer program causes a computer to execute the method according to the first aspect or the second aspect.

In embodiments of the present application, a terminal device receives one or more PRACH configurations transmitted by a network device, so that PRACH transmission can be more flexible, and PRACH transmission performance is improved.

### BRIEF DESCRIPTION OF THE DRAWINGS

FIG. 1 is an example diagram of a system architecture of a wireless communications system to which embodiments of the present application are applicable.

FIG. 2 is a schematic flowchart of a wireless communication method according to an embodiment of the present application.

FIG. 3 is a schematic flowchart of a wireless communication method according to another embodiment of the present application.

FIG. 4 is a schematic structural diagram of a terminal device according to an embodiment of the present application.

FIG. 5 is a schematic structural diagram of a network device according to an embodiment of the present application.

FIG. 6 is a schematic diagram of an apparatus for communication according to an embodiment of the present application.

### DETAILED DESCRIPTION OF THE EMBODIMENTS

The technical solutions in the present application are described below with reference to the accompanying drawings.

### Wireless communications system

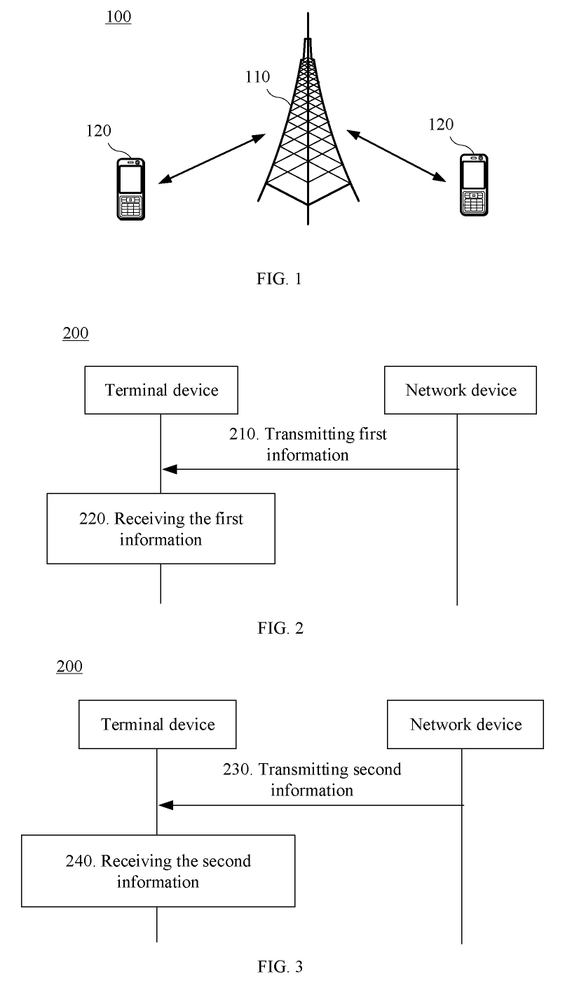

FIG. 1 is an example diagram of a system architecture of a wireless communications system 100 to which embodiments of the present application are applicable. The wireless communications system 100 may include a network device 110 and a terminal device 120. The network device 110 may be a device that communicates with the terminal device 120. The network device 110 may provide network coverage for a specific geographic area, and may communicate with the terminal device 120 within the coverage. The terminal device 120 may access a network such as a wireless network by using the network device 110. Optionally, the wireless communications system 100 may further include another network entity such as a network controller or a mobility management entity. This is not limited in the embodiments of the present application.

It should be understood that the technical solutions in the embodiments of the present application may be applied to various communications systems, for example, a fifth generation (fifth generation, 5G) system or new radio (new radio, NR), a long term evolution (long term evolution, LTE) system, an LTE frequency division duplex (frequency division duplex, FDD) system, and LTE time division duplex (time division duplex, TDD) system. The technical solutions provided in the present application may be further applied to a future communications system, such as a sixth generation mobile communications system or a satellite communications system.

In the embodiments of the present application, the terminal device may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in the embodiments of the present application may be a device providing a user with voice and/or data connectivity and capable of connecting people, objects, and machines, such as a handheld device or vehicle-mounted device having a wireless connection function. The terminal device may alternatively be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in smart grid (smart grid), a wireless terminal in transportation safety (transportation safety), a wireless terminal in smart city (smart city), a wireless terminal in smart home (smart home), or the like. Optionally, the terminal device may function as a base station. For example, the terminal device may function as a scheduling entity, which provides a sidelink signal between terminal devices in vehicle-to-everything (vehicle to everything, V2X), device-to-device (device to device, D2D), or the like. For example, a cellular phone and a vehicle communicate with each other by using a sidelink signal. A cellular phone and a smart home device communicate with each other, without relaying a communication signal by using a base station.

In the embodiments of the present application, the network device may be a device for communicating with a terminal device. The network device may be an access network device or a radio access network device. For example, the network device may be a base station. The base station may broadly cover various names below, or may be replaced with the following names, such as a NodeB (NodeB), an evolved NodeB (evolved NodeB, eNB), a next generation NodeB (next generation NodeB, gNB), a relay station, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device form used by the network device are not limited in the embodiments of the present application. The base station may support networks of a same access technology or different access technologies. A specific technology and a specific device form used by the network device are not limited in the embodiments of the present application.

In addition, the base station may be fixed or mobile. For example, a helicopter or an unmanned aerial vehicle may be configured to function as a mobile base station, and one or more cells may move depending on a location of the mobile base station. In another example, a helicopter or an unmanned aerial vehicle may be configured to serve as a device that communicates with another base station.

The network device and the terminal device may be deployed on land, including being indoors or outdoors, handheld, or vehicle-mounted, may be deployed on a water surface, or may be deployed on a plane, a balloon, or a satellite in the air. In the embodiments of the present application, a scenario in which the network device and the terminal device are located is not limited.

It should be understood that all or some of functions of the communications device in the present application may also be implemented by software functions running on hardware, or by virtualization functions instantiated on a platform such as a cloud platform.

In an NR system, a random access procedure allows a terminal device to initiate a connection request to a network device when the terminal device is powered on for the first time or restored from a sleep state. When the terminal device needs to be handed over to a new cell, a connection is re-established by using the random access procedure. By using the random access procedure, the terminal device may request the network device to allocate a resource to the terminal device, so as to perform data transmission or other communication. When traffic changes, the terminal device may dynamically request a required resource by using a PRACH, so as to improve network flexibility. A probability of a collision may be effectively reduced by using a random preamble (preamble), and the collision is processed by using a retransmission mechanism. An event that triggers the random access procedure may include, for example, initial access from a radio resource control (radio resource control, RRC) idle (RRC_IDLE) state, an RRC connection re-establishment process, a scheduling request (scheduling request, SR) failure, and beam failure recovery. Therefore, the random access procedure may be performed when the terminal device is in the RRC idle state, an RRC inactive (RRC_INACTIVE) state, and an RRC connected (RRC_CONNECTED) state. To enable the terminal device in a network to have an opportunity to perform random access, the network device needs to configure a PRACH resource for the terminal device, so as to receive a random access preamble from the terminal device. In an example, the terminal device may obtain a PRACH configuration by using higher layer signaling, so as to obtain a PRACH resource in time domain. Each PRACH configuration has a corresponding index, each PRACH configuration corresponds to random access occasion (random access occasion, RO) distribution, and the RO distribution is generally defined by a radio frame index, an intra-frame subframe number, and a start symbol in a slot.

In the random access procedure, the terminal device first monitors system information such as a system information block (system information block, SIB) 1 and a SIB 2 transmitted by the network device, so as to learn configuration and availability of the PRACH resource. Then, the terminal device selects a PRACH preamble based on the obtained PRACH configuration, to perform random access. The terminal device transmits the random access preamble in a predetermined PRACH slot, and the network device performs processing after receiving the preamble.

In NR, random access is a periodic and always existing process, and a PRACH resource is usually fixed. However, density of requesting access by the terminal device changes with time. When user density is relatively low, excessive PRACH resources may cause resource waste. In such a cell, even if there is no or light traffic, the network device may still need to frequently detect a PRACH. Consequently, additional energy consumption is caused, which is not conducive to network energy saving (network energy saving, NES). When density of terminal devices is relatively high, insufficient PRACH resources may cause access congestion. To implement network energy saving, when system load is relatively low, the network device may shorten a monitoring time or prolong a sleep time between ROs. However, a PRACH configuration can only be updated by using a SIB 1, and even if a quantity of terminal devices in a cell suddenly decreases significantly and most of configured ROs are not used by the terminal devices to execute random access programs, the network device may still need to monitor each configured RO. Apparently, this case is not conducive to network energy saving.

In a low load scenario, a period of PRACH transmission is adaptively adjusted in time domain, so that the network device may reduce unnecessary monitoring, thereby entering a longer sleep state. However, the network device further needs to ensure that a delay of the terminal device is not significantly affected. The PRACH configuration is provided based on a specific use scenario of the random access procedure by using the SIB 1, an RRC message, or the like. Therefore, in principle, the network device may change the PRACH configuration by updating system information or performing RRC reconfiguration. However, frequent SIB 1 updating or frequent RRC reconfiguration also adversely affects network energy saving and signaling overheads.

Therefore, embodiments of the present application provide a wireless communication method. A terminal device receives one or more PRACH configurations transmitted by a network device, so that PRACH transmission can be more flexible, and PRACH transmission performance is improved. In other words, one or more PRACH configurations are used to dynamically adjust a PRACH resource, so that PRACH transmission can be adaptive to changes in factors such as traffic and load, a network energy saving requirement, distribution of terminal devices, and a time, thereby optimizing resource utilization and balancing initial access performance of terminal devices.

It may be understood that, for a legacy terminal device, for example, a terminal device supporting a relatively low protocol version (for example, a Release 18 in NR and a previous version thereof), a network device indicates a PRACH configuration for the terminal device by using system information or an RRC message, where the configuration is referred to as a basic PRACH configuration or a reference PRACH configuration below, and a PRACH period included in the basic PRACH configuration is referred to as a basic period or a reference period. Various PRACH parameters included in the basic PRACH configuration may be adjusted, but need to be updated by using system information or an RRC message. The reference PRACH configuration may also be used by a terminal device supporting a higher version (for example, a Release 19 in NR and a later protocol version thereof). In addition, the terminal device supporting the higher version may further obtain a plurality of additional PRACH configurations, that is, additional PRACH resources, to perform uplink access. In the future, there may be more terminal devices supporting the higher version, a plurality of additional PRACH configurations are provided for the terminal devices, and a PRACH configuration adapted to a current scenario is activated for a terminal device, so that network energy saving can be implemented when an uplink access requirement is met.

Embodiments of the present application are described in detail below with reference to FIG. 2.

FIG. 2 is a schematic flowchart of a wireless communication method according to an embodiment of the present application. The method 200 shown in FIG. 2 may be performed by a terminal device and a network device. The terminal device may be for example the terminal device 120 shown in FIG. 1, and the network device may be for example the network device 110 shown in FIG. 1.

Referring to FIG. 2, in step 210, the network device transmits first information to the terminal device.

Correspondingly, in step 220, the terminal device receives the first information transmitted by the network device.

The first information includes one or more PRACH configurations. For example, the first information is carried in an RRC message or system information (for example, a SIB 1 or a SIB 2). It may be understood that, the one or more PRACH configurations may be PRACH configurations that are additionally configured by the network device for a terminal device supporting a higher version (for example, a Release 19 in NR and a later protocol version thereof). Parameters in the one or more PRACH configurations may be at least partially different from parameters in a basic PRACH configuration (for example, a PRACH configuration configured by the network device for a terminal device supporting a Release 18 in NR and a previous version thereof). Alternatively, parameters in the one or more PRACH configurations are the same as parameters in a basic PRACH configuration, but the parameters in the one or more PRACH configurations may be adjusted by using second information. For details about the second information, reference may be made to subsequent description.

For example, the PRACH configuration may include one or more of the following parameters: an index of the PRACH configuration; a period of a PRACH resource; a subframe number corresponding to a PRACH slot; a quantity of PRACH slots; a quantity of ROs in a PRACH slot; an RO interval; an RO offset; or an offset of an index of the PRACH configuration relative to an index of the basic PRACH configuration. The subframe number corresponding to the PRACH slot indicates a subframe including the PRACH slot used for PRACH transmission, and the terminal device needs to perform random access in the slot. The quantity of PRACH slots indicates a quantity of slots that are in the subframe corresponding to the subframe number and that are allocated to the terminal device to perform PRACH transmission. The quantity of ROs indicates a quantity of ROs that are in each PRACH resource (for example, a PRACH slot) and that may be used to perform random access. The period of the PRACH resource, which is also referred to as a period for transmitting a PRACH or a PRACH period below, indicates a time interval at which the PRACH resource repeatedly appears. This parameter affects an occasion, that is, an RO, on which the terminal device transmits a random access request. Each PRACH resource may include a plurality of RO locations, and an interval between adjacent RO locations in the plurality of RO locations is referred to as an RO interval. The RO offset in the PRACH configuration indicates an offset of an RO in each PRACH resource relative to a specific reference point (for example, a calculation start point of the PRACH resource). The RO interval may be for example a parameter x shown in the table 6.3.3.2 in the protocol 38.211, and the RO offset may be for example a parameter y shown in the table 6.3.3.2 in the protocol 38.211.

Some or all of the above parameters (for example, the period of the PRACH resource, the subframe number corresponding to the PRACH slot, the quantity of PRACH slots, the quantity of ROs in the PRACH slot, the RO interval, and the RO offset) in different PRACH configurations in the plurality of PRACH configurations may be different. The plurality of PRACH configurations may have respective indexes, for example, a PRACH configuration #1, a PRACH configuration #2, ..., and a PRACH configuration #N.

As described above, the network device may further transmit the basic PRACH configuration to the terminal device, and correspondingly, the terminal device receives the basic PRACH configuration transmitted by the network device. The basic PRACH configuration may be for example carried in an RRC message or system information (for example, a SIB 1). The basic PRACH configuration includes a basic period used for PRACH transmission. When configuring a PRACH resource, the network device provides the basic PRACH configuration for a legacy terminal device, and configures one or more additional PRACH configurations (that is, the one or more PRACH configurations indicated in the first information) for the terminal device supporting the higher version. The one or more additional PRACH configurations may share some parameters with the basic PRACH configuration, for example, the basic PRACH configuration and the PRACH configurations that are additionally configured include same parameters such as the subframe number corresponding to the PRACH slot, the quantity of PRACH slots, the quantity of ROs in the PRACH slot, and the RO offset, and a difference lies only in the PRACH period and/or the RO interval. In addition, the additional PRACH configuration may include another period different from the basic period in the basic PRACH configuration. In some implementations, the period included in the additional PRACH configuration is less than the basic PRACH period, and/or an RO interval included in the additional PRACH configuration is less than an RO interval in the basic PRACH configuration. For example, each of the one or more periods in the first information is 1/2^{M} of the basic period, M associated with the one or more periods may have different values, and M is a positive integer.

For a same quantity of SSBs, gains of network energy saving usually increase as a quantity of PRACH configurations increases. The network device notifies, by using the index of the PRACH configuration indicated in the SIB 1 or the RRC message, the terminal device of a time resource used for PRACH transmission, for example, a period, a subframe, a slot, and a used orthogonal frequency division multiplexing (orthogonal frequency division multiplexing, OFDM) symbol. Therefore, the network device may configure, for the legacy terminal device, a PRACH configuration that is always online and that includes the basic period, and configure, for the terminal device supporting the higher version, one or more additional PRACH configuration, that is, flexible and adjustable PRACH configurations, that are different from the basic PRACH configuration, so that adaptive decision of the network device can be more dynamic. The network device may notify, by using new signaling (for example, carrying the second information), the terminal device supporting the higher version of a PRACH configuration that needs to be used currently (which may be the basic PRACH configuration or the one or more additional PRACH configurations), so that the configuration can be adapted to a current scenario, and uplink access performance of the legacy terminal device is not affected.

As a quantity of terminal devices supporting the higher version increases, in addition to the basic PRACH configuration, more PRACH resources are additionally configured to meet access requirements of more terminal devices. For example, when there is relatively high load, a period of PRACH transmission is decreased to increase PRACH resources, so that access congestion caused by insufficient PRACH resources can be avoided. When the load is lightened, the period of PRACH transmission is increased to decrease PRACH resources, which is conducive to network energy saving.

For example, the basic PRACH configuration and the one or more additional PRACH configurations may be transmitted to the terminal device at the same time (for example, carried in a same message), or may be transmitted to the terminal device independently (for example, carried in different messages). In order not to affect uplink access of the legacy terminal device, the basic PRACH configuration still exists, because the legacy terminal device may not be able to parse the first information and/or the second information transmitted to the terminal device supporting the higher version.

In some implementations, as shown in FIG. 3, the method 200 may further include step 230 and step 240. In step 230, the network device transmits the second information to the terminal device, and correspondingly, in step 240, the terminal device receives the second information transmitted by the network device. For example, the second information may be carried in a medium access control control element (media access control control element, MAC CE) or downlink control information (downlink control information, DCI).

The second information may be used to instruct to adjust a parameter in the first PRACH configuration. For example, the first information may include an additional PRACH configuration, and the second information may be used to instruct the terminal device to adjust a parameter in the PRACH configuration, for example, adjusting parameters such as a period of a PRACH resource, a quantity of ROs, and an RO interval in the PRACH configuration. In an example, the second information may be indication information used to instruct to increase the period of the PRACH resource, indication information used to instruct to decrease the period of the PRACH resource, indication information used to instruct to increase the RO interval, indication information used to instruct to decrease the RO interval, or indication information used to instruct to adjust another parameter in the PRACH configuration.

Alternatively, the second information is used to activate the first PRACH configuration in the one or more PRACH configurations. The network device configures a plurality of additional PRACH configurations for the terminal device by using, for example, system information or an RRC configuration, and indicates, by using, for example, an RRC message, system information, a MAC CE, or DCI, a PRACH configuration that needs to be activated, that is, the first PRACH configuration. The network device may simultaneously activate one or more PRACH configurations by using the second information. For example, during activation of one PRACH configuration, an index of the PRACH configuration may be carried in the second information, and during activation of a plurality of PRACH configurations, a set of indexes of the plurality of PRACH configurations may be carried in the second information.

Optionally, the network device may configure one or more PRACH configurations for the terminal device by using the first information and activate the first PRACH configuration or adjust a parameter in the first PRACH configuration by using the second information at the same time, or may activate the first PRACH configuration or adjust a parameter in the first PRACH configuration by using the second information after configuring one or more PRACH configurations for the terminal device by using the first information. In a case in which the first information and the second information are transmitted simultaneously, when just accessing a cell, the terminal device may obtain both the first information and information about an additional PRACH configuration. In this way, when just accessing a cell, the terminal device supporting the higher version does not compete, with the legacy terminal device, a PRACH resource that is applicable to uplink access of the legacy terminal device, thereby reducing a probability of a PRACH resource conflict.

In comparison with the basic PRACH configuration, in this embodiment of the present application, there is no need to update system information, and a PRACH configuration that needs to be used by the terminal device in a plurality of PRACH configurations that are previously configured for the terminal device by using higher layer signaling can be indicated to the terminal device by using the second information, that is, in a case in which the system information does not need to be updated, an additional PRACH resource is provided for uplink access of the terminal device based on a requirement of a current scenario by using dynamic signaling. PRACH receiving activities are reduced, so that longer sleep of the network device can be implemented, and PRACH resources are increased, so that congestion caused when a large quantity of terminal devices have access requirements can be avoided.

Because the one or more PRACH configurations described above have respective indexes, the second information may carry the index of the first PRACH configuration that needs to be activated. In an example, if the network device configures three additional PRACH configurations for the terminal device, corresponding indexes are respectively a PRACH configuration #1, a PRACH configuration #2, and a PRACH configuration #3, and if the index of the first PRACH configuration that needs to be activated is the PRACH configuration #1, the second information carries the PRACH configuration #1; if the index of the first PRACH configuration that needs to be activated is the PRACH configuration #2, the second information carries the PRACH configuration #2; and if the index of the first PRACH configuration that needs to be activated is the PRACH configuration #3, the second information carries the PRACH configuration #3. Certainly, the second information may also carry the index of the basic PRACH configuration. When the index of the basic PRACH configuration is a PRACH configuration #0, and the second information carries the PRACH configuration #0, the terminal device may perform uplink access based on the basic PRACH configuration. The second information may also carry indexes of a plurality of PRACH configurations. In this case, the terminal device may perform uplink access based on the plurality of PRACH configurations, for example, performing uplink access by using an RO determined based on different periods in one or more PRACH configurations.

In some implementations, the index of the first PRACH configuration is adjacent to an index of a second PRACH configuration, and the second PRACH configuration is a PRACH configuration that is activated at a previous time. In other words, the network device may activate PRACH configurations based on a sequence of indexes, for example, the network device configures three PRACH configurations for the terminal device, and corresponding indexes are respectively a PRACH configuration #1, a PRACH configuration #2, and a PRACH configuration #3, where a period in the PRACH configuration #1 < a period in the PRACH configuration #2 < a period in the PRACH configuration #3. If the PRACH configuration that is activated at the previous time is the PRACH configuration #2, and if a period of PRACH transmission needs to be increased, the network device instructs, by using the second information, the terminal device to activate a PRACH configuration whose index is the PRACH configuration #3 after the PRACH configuration #2; or if a period of PRACH transmission needs to be decreased, the network device instructs, by using the second information, the terminal device to activate a PRACH configuration whose index is the PRACH configuration #1 before the PRACH configuration #2.

In addition to activating a PRACH configuration, that is, the first PRACH configuration, in the one or more PRACH configurations so that various parameters in the first PRACH configuration take effect, the network device may also activate a period in different periods included in the one or more PRACH configurations, and other parameters in the PRACH configurations keep unchanged. In this case, the second information may also include information about a period in the first PRACH configuration. Optionally, if the network device configures a plurality of periods for the terminal device, and the plurality of periods have corresponding indexes, the second information may include an index of the first period in a plurality of periods that needs to be activated. In an example, if the network device configures three periods of a PRACH resource for the terminal device, corresponding indexes are respectively a period #1, a period #2, and a period #3, and if the index of the first period that needs to be activated is the period #1, the second information carries the period #1; if the index of the first period that needs to be activated is the period #2, the second information carries the period #2; and if the index of the first period that needs to be activated is the period #3, the second information carries the period #3. Certainly, the second information may also carry an index of the basic period (for example, a period in the basic PRACH configuration). When the index of the basic period is a period #0, and the second information carries the period #0, the terminal device may perform uplink access based on the basic period. The second information may also carry indexes of a plurality of periods. In this case, the terminal device may perform uplink access based on the plurality of periods, for example, performing uplink access by using an RO determined based on the plurality of periods.

In some implementations, the index of the first period is adjacent to an index of a second period, and the second period is a period that is activated at a previous time. In other words, the network device may activate periods based on a sequence of indexes. In an example, the network device configures three periods for the terminal device, and corresponding indexes are respectively a period #1, a period #2, and a period #3. A first period of the period #1 < a second period of the period #2 < a third period of the period #3. If the period that is activated at the previous time is the period #2, and if the period of the PRACH resource needs to be increased, the network device instructs, by using the second information, the terminal device to activate a period whose index is the period #3 after the period #2; and if a period of PRACH transmission needs to be decreased, the network device instructs, by using the second information, the terminal device to activate a period whose index is the period #1 before the period #2.

In another implementation, the second information may further include indication information for increasing the period of the PRACH resource or indication information for decreasing the period of the PRACH resource. In other words, the network device may instruct the terminal device to increase or decrease, based on a predetermined rule, a period that is of a PRACH resource and that is currently used. For example, the first period may be 1/N1 of the second period that is activated at the previous time, and N1 is a positive integer (for example, N1=2); or the first period is N2 times the second period, and N2 is a positive integer (for example, N2=2); or the first period is a result obtained after the second period is increased by a first proportion (that is, the first period is obtained after the second period is increased by the first proportion); or the first period is a result obtained after the second period is decreased by a second proportion (that is, the first period is obtained after the second period is decreased by the second proportion). The first proportion and the second proportion are for example greater than 0 and less than 1. A possible value of the first period that becomes larger or smaller is specified in advance or configured by the network device. In an example, a period of a PRACH resource may include 20 ms, 40 ms, 80 ms, 120 ms, and 160 ms, and a currently used period is 80 ms. If the network device instructs, by using the second information, to activate a new period, and the new period is twice the current period, the terminal device switches a period of PRACH transmission from 80 ms to 160 ms, and performs PRACH transmission based on the new period of 160 ms. If the network device instructs, by using the second information, to activate a new period, and the new period is half of the current period, the terminal device switches a period of PRACH transmission from 80 ms to 40 ms, and performs PRACH transmission based on the new period of 40 ms. If the network device instructs, by using the second information, to activate a new period, and the new period is obtained after the current period is increased by 50%, the terminal device switches a period of PRACH transmission from 80 ms to 120 ms, and performs PRACH transmission based on the new period of 120 ms. If the network device instructs, by using the second information, to activate a new period, and the new period is obtained after the current period is decreased by 75%, the terminal device switches a period of PRACH transmission from 80 ms to 20 ms, and performs PRACH transmission based on the new period of 20 ms. It should be noted that the plurality of periods described above may be a plurality of periods included in the plurality of PRACH configurations, or may be different from the plurality of periods configured in the plurality of PRACH configurations.

In another implementation, the second information may further include one or more of the following information: information about an RO interval in the first PRACH configuration; information about an RO offset in the first PRACH configuration; indication information for increasing the RO interval; or indication information for decreasing the RO interval. For a process of adjusting the RO interval, reference may be made to the foregoing adjustment process of adjusting the period of the PRACH resource by using the second information, and details are not described herein again.

In addition, in some implementations, the second information may further include the offset of the index of the first PRACH configuration relative to the index of the basic PRACH configuration. Optionally, the index of the first PRACH configuration may be one of indexes of a plurality of PRACH configurations associated with a first preamble format, and the first preamble format is a preamble format associated with the basic PRACH configuration. Herein, the indexes of the plurality of PRACH configurations associated with the first preamble format are indexes obtained after reordering, that is, the indexes of the plurality of PRACH configurations associated with the first preamble format may be renumbered to obtain corresponding indexes of the plurality of PRACH configurations. Assuming that a preamble format 0 is associated with an index #0 to an index #27 of PRACH configurations, a preamble format 1 is associated with an index #28 to an index #56 of PRACH configurations, and the index of the basic PRACH configuration is the index #28, the first preamble format is the preamble format 1. Therefore, the index of the first PRACH configuration should be one of the index #28 to the index #56 of the PRACH configurations associated with the preamble format 1. Alternatively, the PRACH configurations associated with the preamble format 1 may also be reordered based on a sequence of indexes, and indexes of the reordered PRACH configurations are an index #0 to an index #28, and therefore, the index of the first PRACH configuration should be one of the index #0 to the index #28. In a manner of indicating an index offset by using the second information, overheads of physical layer signaling can be saved.

As described above, the network device may dynamically deactivate (or disable) or activate (or enable) a PRACH configuration in the one or more additional PRACH configurations. A PRACH configuration that is not activated and that is indicated by the network device is disabled, and the network device does not need to monitor an RO location determined based on these PRACH configurations, thereby implementing energy saving. When a PRACH configuration in the one or more additional PRACH configurations is activated, the terminal device supporting the higher version preferably selects an RO location determined based on the PRACH configuration to perform uplink access, so that random access congestion at an RO location determined based on the basic PRACH configuration can be avoided. When a large quantity of terminal devices have access requirements, an additional PRACH configuration is activated to provide more RO resources, thereby reducing collisions in a random access procedure.

In NR, a beam is used in the random access procedure. There are a plurality of occasions for transmitting SSBs in a time domain period, and the SSBs have corresponding numbers and respectively correspond to different beams. For a terminal device, only when a beam sweeping signal of an SSB covers the terminal device, the terminal device has an opportunity to transmit a preamble. When receiving the preamble of the terminal device, the network device learns an optimal downlink beam, that is, learning which beam points to the terminal device. Therefore, an SSB needs to be associated with a preamble, and the preamble is transmitted on an RO. As a result, there is generally a predetermined mapping relationship between the SSB and the RO. In other words, when a PRACH configuration is determined, an RO location is determined, and there is a mapping relationship between an SSB and the RO location. For example, the basic PRACH configuration is used as an example. It is assumed that an SSB burst (SSB burst) includes four SSBs, and corresponding SSB indexes (SSB index) are respectively an SSB #0, an SSB #1, an SSB #2, and an SSB #3. For example, the mapping relationship may be as follows: the SSB #0 is mapped to an RO location 0, the SSB #1 is mapped to an RO location 1, the SSB #2 is mapped to an RO location 2, and the SSB #3 is mapped to an RO location 3. The RO location 0, the RO location 1, the RO location 2, and the RO location 3 may be determined based on a related parameter in the basic PRACH configuration, for example, an interval between two adjacent RO locations in the RO location 0, the RO location 1, the RO location 2, and the RO location 3 may be equal to the basic period. In this case, if the terminal device uses a beam corresponding to the SSB #0, the terminal device may perform PRACH transmission at the RO location 0; if the terminal device uses a beam corresponding to the SSB #1, the terminal device may perform PRACH transmission at the RO location 1; if the terminal device uses a beam corresponding to the SSB #2, the terminal device may perform PRACH transmission at the RO location 2; and if the terminal device uses a beam corresponding to the SSB #3, the terminal device may perform PRACH transmission at the RO location 3. One SSB may be mapped to one or more ROs, and one RO may also be mapped to one or more SSBs. In different mapping relationships, different ROs may be associated with a same SSB, and different SSBs may be associated with a same RO, which is not limited in the embodiments of the present application.

When one or more additional PRACH configurations are introduced, it is necessary to consider a mapping relationship between an RO location determined based on a new PRACH configuration and an SSB. If both an RO location determined based on an additional PRACH configuration and the RO location determined based on the basic PRACH configuration are mapped to an SSB, a mapping relationship between the RO location determined based on the basic PRACH configuration and the SSB may be interfered after the additional PRACH configuration is added. In other words, an additional RO location configured for the terminal device supporting the higher version may cause inconsistent mapping from an SSB to an RO location between the legacy terminal device and the terminal device supporting the higher version. Such an inconsistency may result in that the network device cannot determine an SSB corresponding to received PRACH transmission, and cannot obtain a receiving direction by using an SSB corresponding to a PRACH, and the network device can receive a signal only by means of receive beam sweeping, and cannot perform receiving efficiently by means of receive beam forming.

Therefore, in some implementations, an RO determined based on each of the one or more additional PRACH configurations has a first mapping relationship with an SSB, and the RO determined based on the basic PRACH configuration has a second mapping relationship with an SSB. In this case, two mapping relationships are provided, one of the mapping relationships is the second mapping relationship, which is also considered as a legacy mapping relationship, between the RO determined based on the basic PRACH configuration and the SSB, and the other mapping relationship is the first mapping relationship between an RO determined based on an additional PRACH configuration and an SSB. In other words, mapping for the RO determined based on each of the one or more PRACH configurations and mapping for the RO determined based on the basic PRACH configuration are performed separately. The second mapping relationship may be for example used by the legacy terminal device, and the first mapping relationship may be for example used by the terminal device supporting the higher version.

To avoid resource interference between ROs involved in the two mapping relationships, in some implementations, the RO in the first mapping relationship does not overlap with the RO in the second mapping relationship. In other words, in the first mapping relationship, an SSB is only mapped to an RO location different from the RO location in the second mapping relationship. In some other implementations, the RO in the first mapping relationship at least partially overlaps with the RO in the second mapping relationship. For example, in the first mapping relationship, SSBs are mapped to all ROs (for example, including the RO determined based on the basic PRACH configuration and the RO determined based on the additional PRACH configuration) that may be used by the terminal device supporting the higher version, that is, ROs in the first mapping relationship include the RO determined based on the basic PRACH configuration and the RO determined based on the additional PRACH configuration, and the RO in the second mapping relationship includes the RO determined based on the basic PRACH configuration. In this case, the RO in the first mapping relationship may partially overlap with the RO in the second mapping relationship. For the legacy terminal device, a quantity of ROs mapped to one SSB or a quantity of ROs mapped by one SSB are configured by the network device (for example, configured by using an RRC message), and a mapping sequence is predetermined. If both the RO determined based on the basic PRACH configuration and the RO determined based on the additional PRACH configuration are mapped to an SSB, the second mapping relationship between the RO determined based on the basic PRACH configuration and the SSB may be disturbed. Apparently, after the RO determined based on the additional PRACH configuration appears, it is not easy to ensure that the mapping relationship keeps unchanged, because mapping between an SSB and an RO is usually performed in sequence. In this case, when an RO determined based on an additional PRACH configuration is activated, the legacy terminal device makes a change in RO selection. Consequently, unnecessary implementation complexity of the legacy terminal device is caused. Therefore, the RO determined based on the additional PRACH configuration and the RO determined based on the basic PRACH configuration are separately mapped to SSBs, which is conducive to keeping a mapping relationship that is between an SSB and an RO and that is used by the legacy terminal device.

Optionally, for the terminal device supporting the higher version, when different ROs in the first mapping relationship and the second mapping relationship are associated with a same SSB, an RO that is in the first mapping relationship and that is associated with the same SSB is used for PRACH transmission of the terminal device. For the terminal device supporting the higher version, if an additional PRACH configuration is activated and there are two ROs: an RO location determined based on the basic PRACH configuration and an RO determined based on the additional PRACH configuration, associated with a same SSB, when the terminal device supporting the higher version preferentially selects the RO determined based on the basic PRACH configuration, because the RO may be also used by the legacy terminal device to perform random access, congestion on the RO is significantly increased. Therefore, in this case, the RO determined based on the additional PRACH configuration may be preferentially selected by the terminal device supporting the higher version preferentially. In addition, a preamble configuration related to a network energy saving function is transmitted in the RO determined based on the additional PRACH configuration. Therefore, when the network energy saving function or a corresponding PRACH configuration is activated, the terminal device supporting the higher version selects the RO determined based on the additional PRACH configuration.

A case in which mapping for the RO determined based on each of the one or more PRACH configurations and mapping for the RO determined based on the basic PRACH configuration are performed separately is described above. In another implementation, the RO determined based on each of the one or more PRACH configurations and the RO determined based on the basic PRACH configuration may also be mapped together. In other words, the RO determined based on each of the one or more PRACH configurations and the RO determined based on the basic PRACH configuration may be used as a whole to perform mapping with an SSB. For example, an RO determined based on a parameter in the additional PRACH configuration and an RO determined based on a parameter in the basic PRACH configuration have a third mapping relationship with an SSB. In this case, both the terminal device supporting the higher version and the legacy terminal device need to follow the third mapping relationship. Assuming that four RO locations are determined based on the basic PRACH configuration and eight RO locations are determined based on the additional PRACH configuration, the twelve RO locations may be used as a whole to perform mapping with an SSB, so as to obtain the third mapping relationship.

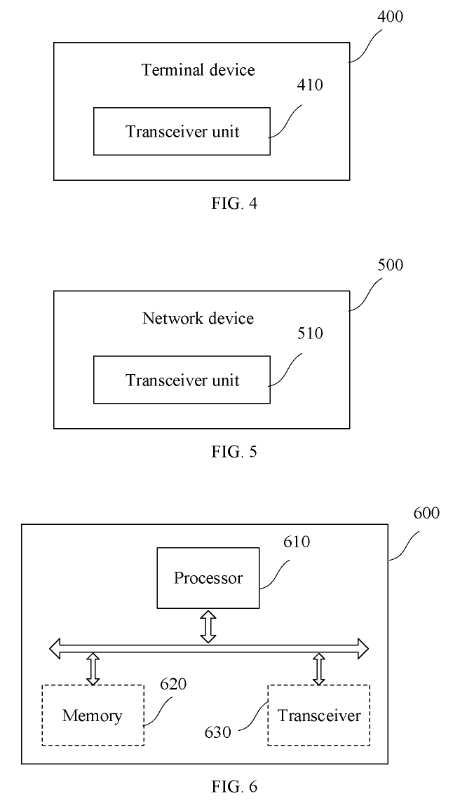

The method embodiments of the present application are described in detail above with reference to FIG. 1 to FIG. 3. Apparatus embodiments of the present application are described in detail below with reference to FIG. 4 and FIG. 6. It should be understood that the description of the method embodiments corresponds to the description of the apparatus embodiments, and therefore, for a part that is not described in detail, reference may be made to the foregoing method embodiments.

FIG. 4 is a schematic structural diagram of a terminal device according to an embodiment of the present application. The terminal device 400 shown in FIG. 4 may include a transceiver unit 410. The transceiver unit 410 is configured to receive first information transmitted by a network device. The first information includes one or more PRACH configurations.

In some implementations, the PRACH configuration includes one or more of the following parameters: an index of the PRACH configuration; a period of a PRACH resource; a subframe number corresponding to a PRACH slot; a quantity of PRACH slots; a quantity of random access channel occasions ROs in a PRACH slot; an RO interval; an RO offset; or an offset of an index of a first PRACH configuration relative to an index of a basic PRACH configuration.

In some implementations, the transceiver unit 410 is further configured to receive second information transmitted by the network device. The second information is used to activate the first PRACH configuration in the one or more PRACH configurations, or used to instruct to adjust a parameter in the first PRACH configuration.

In some implementations, the second information includes one or more of the following information: the index of the first PRACH configuration; information about a period in the first PRACH configuration; information about an RO interval in the first PRACH configuration; information about an RO offset in the first PRACH configuration; indication information for increasing a period of a PRACH resource; indication information for decreasing a period of a PRACH resource; indication information for increasing the RO interval; indication information for decreasing the RO interval; or the offset of the index of the first PRACH configuration relative to the index of the basic PRACH configuration.

In some implementations, the index of the first PRACH configuration is one of indexes of a plurality of PRACH configurations associated with a first preamble format, the first preamble format is a preamble format associated with the index of the basic PRACH configuration, and the indexes of the plurality of PRACH configurations associated with the first preamble format are indexes obtained after reordering.

In some implementations, the index of the first PRACH configuration is adjacent to an index of a second PRACH configuration, and the second PRACH configuration is a PRACH configuration that is activated at a previous time; an index of a first period is adjacent to an index of a second period, the first period is the period in the first PRACH configuration, and the second period is a period in the PRACH configuration that is activated at the previous time; the first period is 1/N1 of the second period, and N1 is a positive integer; the first period is N2 times the second period, and N2 is a positive integer; the first period is a result obtained after the second period is increased by a first proportion; and the first period is a result obtained after the second period is decreased by a second proportion.

In some implementations, the first information is carried in an RRC message or system information; and/or the second information is carried in an RRC message, system information, a MAC CE, or DCI.

In some implementations, the transceiver unit 410 is further configured to receive the basic PRACH configuration transmitted by the network device. The basic PRACH configuration includes a basic period used for PRACH transmission, and the one or more PRACH configurations each include a period different from the basic PRACH period.

In some implementations, the period in the one or more PRACH configurations is less than the basic PRACH period.

In some implementations, the period in the one or more PRACH configurations is 1/2^{M} of the basic period, M associated with the period in the one or more PRACH configurations has different values, and M is a positive integer.

In some implementations, the basic PRACH configuration is carried in an RRC message or system information.

In some implementations, an RO determined based on each of the one or more PRACH configurations has a first mapping relationship with a synchronization signal broadcast channel block SSB, and an RO determined based on the basic PRACH configuration has a second mapping relationship with an SSB.

In some implementations, the RO in the first mapping relationship does not overlap with the RO in the second mapping relationship; or the RO in the first mapping relationship at least partially overlaps with the RO in the second mapping relationship.

In some implementations, when different ROs in the first mapping relationship and the second mapping relationship are associated with a same SSB, an RO that is in the first mapping relationship and that is associated with the same SSB is used for PRACH transmission of the terminal device.

In some implementations, an RO determined based on each of the one or more PRACH configurations and an RO determined based on the basic PRACH configuration have a third mapping relationship with an SSB.

It may be understood that the transceiver unit 410 may be for example a transceiver 630. In addition, optionally, the terminal device 400 further includes a processor 610 and a memory 620. For details, reference may be made to FIG. 6.

FIG. 5 is a schematic structural diagram of a network device according to an embodiment of the present application. The network device 500 shown in FIG. 5 may include a transceiver unit 510. The transceiver unit 510 is configured to transmit first information to a terminal device. The first information includes one or more PRACH configurations.

In some implementations, the PRACH configuration includes one or more of the following parameters: an index of the PRACH configuration; a period of a PRACH resource; a subframe number corresponding to a PRACH slot; a quantity of PRACH slots; a quantity of random access channel occasions ROs in a PRACH slot; an RO interval; an RO offset; or an offset of an index of a first PRACH configuration relative to an index of a basic PRACH configuration.

In some implementations, the transceiver unit 510 is further configured to transmit second information to the terminal device. The second information is used to activate the first PRACH configuration in the one or more PRACH configurations, or used to instruct to adjust a parameter in the first PRACH configuration.

In some implementations, the second information includes one or more of the following information: the index of the first PRACH configuration; information about a period in the first PRACH configuration; information about an RO interval in the first PRACH configuration; information about an RO offset in the first PRACH configuration; indication information for increasing a period of a PRACH resource; indication information for decreasing a period of a PRACH resource; indication information for increasing the RO interval; indication information for decreasing the RO interval; or the offset of the index of the first PRACH configuration relative to the index of the basic PRACH configuration.

In some implementations, the index of the first PRACH configuration is one of indexes of a plurality of PRACH configurations associated with a first preamble format, the first preamble format is a preamble format associated with the index of the basic PRACH configuration, and the indexes of the plurality of PRACH configurations associated with the first preamble format are indexes obtained after reordering.

In some implementations, the index of the first PRACH configuration is adjacent to an index of a second PRACH configuration, and the second PRACH configuration is a PRACH configuration that is activated at a previous time; an index of a first period is adjacent to an index of a second period, the first period is the period in the first PRACH configuration, and the second period is a period in the PRACH configuration that is activated at the previous time; the first period is 1/N1 of the second period, and N1 is a positive integer; the first period is N2 times the second period, and N2 is a positive integer; the first period is a result obtained after the second period is increased by a first proportion; and the first period is a result obtained after the second period is decreased by a second proportion.

In some implementations, the first information is carried in an RRC message or system information; and/or the second information is carried in an RRC message, system information, a MAC CE, or DCI.

In some implementations, the transceiver unit 510 is further configured to transmit the basic PRACH configuration to the terminal device. The basic PRACH configuration includes a basic period used for PRACH transmission, and the one or more PRACH configurations each include a period different from the basic PRACH period.

In some implementations, the period in the one or more PRACH configurations is less than the basic PRACH period.

In some implementations, the period in the one or more PRACH configurations is 1/2^{M} of the basic period, M associated with the period in the one or more PRACH configurations has different values, and M is a positive integer.

In some implementations, the basic PRACH configuration is carried in an RRC message or system information.

In some implementations, an RO determined based on each of the one or more PRACH configurations has a first mapping relationship with a synchronization signal broadcast channel block SSB, and an RO determined based on the basic PRACH configuration has a second mapping relationship with an SSB.

In some implementations, the RO in the first mapping relationship does not overlap with the RO in the second mapping relationship; or the RO in the first mapping relationship at least partially overlaps with the RO in the second mapping relationship.

In some implementations, when different ROs in the first mapping relationship and the second mapping relationship are associated with a same SSB, an RO that is in the first mapping relationship and that is associated with the same SSB is used for PRACH transmission of the terminal device.

In some implementations, an RO determined based on each of the one or more PRACH configurations and an RO determined based on the basic PRACH configuration have a third mapping relationship with an SSB.

It may be understood that the transceiver unit 510 may be for example a transceiver 630. In addition, optionally, the network device 500 further includes a processor 610 and a memory 620. For details, reference may be made to FIG. 6.

FIG. 6 is a schematic structural diagram of an apparatus for communication according to an embodiment of the present application. The dashed lines shown in FIG. 6 indicate that the unit or module is optional. The apparatus 600 may be configured to implement the method described in the foregoing method embodiments. The apparatus 600 may be for example a chip, a terminal device, or a network device.

The apparatus 600 may include one or more processors 610. The processor 610 may support the apparatus 600 in implementing the method described in the foregoing method embodiments. The processor 610 may be a general-purpose processor or a dedicated processor. For example, the processor 610 may be a central processing unit (central processing unit, CPU). Alternatively, the processor 610 may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or may be any conventional processor or the like.

The apparatus 600 may further include one or more memories 620. The memory 620 stores a program, and the program may be executed by the processor 610, so that the processor 610 executes the method described in the foregoing method embodiments. The memory 620 may be separate from the processor 610 or may be integrated into the processor 610.

The apparatus 600 may further include a transceiver 630. The processor 610 may communicate with another device or chip by using the transceiver 630. For example, the processor 610 may transmit data to and receive data from another device or chip by using the transceiver 630.

An embodiment of the present application further provides a communications system. The communications system includes the terminal device and the network device that are described above. In some implementations, the system further includes another device that interacts with the terminal device and the network device.

An embodiment of the present application further provides a computer-readable storage medium for storing a program. The computer-readable storage medium may be applied to a terminal device or a network device provided in embodiments of the present application, and the program causes a computer to execute a method executed by the terminal device or the network device in various embodiments of the present application.

An embodiment of the present application further provides a computer program product. The computer program product includes a program. The computer program product may be applied to a terminal device or a network device provided in embodiments of the present application, and the program causes a computer to execute a method executed by the terminal device or the network device in various embodiments of the present application.

An embodiment of the present application further provides a computer program. The computer program may be applied to a terminal device or a network device provided in embodiments of the present application, and the computer program causes a computer to execute a method executed by the terminal device or the network device in various embodiments of the present application.

It should be understood that the terms “system” and “network” in embodiments of the present application may be used interchangeably. In addition, the terms used in the present application are only used to explain specific embodiments of the present application, and are not intended to limit the present application. The terms “first”, “second”, “third”, “fourth”, and the like in the specification, claims, and accompanying drawings of the present application are used to distinguish between different objects, rather than to describe a specific order. In addition, the terms “include” and “have” and any variations thereof are intended to cover a non-exclusive inclusion.

In embodiments of the present application, “indication” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “pre-definition” or “pre-configuration” may be implemented by pre-storing corresponding code or a corresponding table in a device (for example, including a terminal device and a network device) or in other manners that can be used for indicating related information. A specific implementation thereof is not limited in the present application. For example, pre-definition may refer to being defined in a protocol.

In embodiments of the present application, the “protocol” may refer to a standard protocol in the communications field, which may include, for example, an LTE protocol, an NR protocol, and a related protocol applied to a future communications system. This is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between associated objects.

In embodiments of the present application, sequence numbers of the foregoing processes do not mean execution sequences. The execution sequences of the processes should be determined based on functions and internal logic of the processes, and should not be construed as any limitation on the implementation processes of the embodiments of the present application.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be indirect couplings or communication connections implemented through some interfaces, apparatus, or units, and may be implemented in electronic, mechanical, or other forms.

Units described as separate components may be or may not be physically separate, and components displayed as units may be or may not be physical units, that is, may be located in one place or distributed on a plurality of network units. Some or all of the units may be selected based on actual requirements to achieve objectives of solutions of the embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of the embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, first information from a network device, wherein the first information comprises one or more physical random access channel (PRACH) configurations;
receiving, by the terminal device, second information from the network device, wherein the second information indicates to activate a first PRACH configuration in the one or more PRACH configurations, or instruct to adjust a parameter in the first PRACH configuration; and
performing, by the terminal device, at least one of the following:
activating the first PRACH configuration in the one or more PRACH configurations; or
adjusting a parameter in the first PRACH configuration.

2. The method according to claim 1, wherein the parameter comprises at least one of the following:
an index of the PRACH configuration;
a period of a PRACH resource;
a subframe number corresponding to a PRACH slot;
a quantity of PRACH slots;
a quantity of random access channel occasions ROs in a PRACH slot;
an RO interval;
an RO offset; or
an offset of an index of the first PRACH configuration relative to an index of a basic PRACH configuration.

3. The method according to claim 1, wherein the second information comprises one or more of following information:
an index of the first PRACH configuration;
information about a period in the first PRACH configuration;
information about an RO interval in the first PRACH configuration;
information about an RO offset in the first PRACH configuration;
indication information for increasing a period of a PRACH resource;
indication information for decreasing a period of a PRACH resource;
indication information for increasing the RO interval;
indication information for decreasing the RO interval; or
an offset of the index of the first PRACH configuration relative to an index of a basic PRACH configuration.

4. The method according to claim 3, wherein the index of the first PRACH configuration is one of indexes of a plurality of PRACH configurations associated with a first preamble format, the first preamble format is a preamble format associated with the index of the basic PRACH configuration, and the indexes of the plurality of PRACH configurations associated with the first preamble format are indexes obtained after reordering.

5. The method according to claim 3, wherein
the index of the first PRACH configuration is adjacent to an index of a second PRACH configuration, and the second PRACH configuration is a PRACH configuration that is activated at a previous time;
an index of a first period is adjacent to an index of a second period, the first period is the period in the first PRACH configuration, and the second period is a period in the PRACH configuration that is activated at the previous time;
the first period is 1/N1 of the second period, and N1 is a positive integer;
the first period is N2 times the second period, and N2 is a positive integer;
the first period is a result obtained after the second period is increased by a first proportion; and
the first period is a result obtained after the second period is decreased by a second proportion.

6. The method according to claim 3, wherein
the first information is carried in a radio resource control (RRC) message or system information; or
the second information is carried in an RRC message, system information, a medium access control control element (MAC CE), or downlink control information (DCI).

7. The method according to claim 1, wherein the method further comprises:
receiving, by the terminal device, a basic PRACH configuration from the network device, wherein the basic PRACH configuration comprises a basic period used for PRACH transmission, and each PRACH configuration of the one or more PRACH configurations comprise a period different from the basic period.

8. The method according to claim 7, wherein the period in the one or more PRACH configurations is less than the basic PRACH period.

9. The method according to claim 8, wherein the period in the one or more PRACH configurations is 1/2^{M} of the basic period, M associated with the period in each of the one or more PRACH configurations has different values, and M is a positive integer.

10. The method according to claim 7, wherein the basic PRACH configuration is carried in an RRC message or system information.

11. The method according to claim 1, wherein an RO determined based on each of the one or more PRACH configurations has a first mapping relationship with a synchronization signal broadcast channel block (SSB), and an RO determined based on a basic PRACH configuration has a second mapping relationship with an SSB.

12. The method according to claim 11, wherein
the RO in the first mapping relationship does not overlap with the RO in the second mapping relationship; or
the RO in the first mapping relationship at least partially overlaps with the RO in the second mapping relationship.

13. The method according to claim 11, wherein when different ROs in the first mapping relationship and the second mapping relationship are associated with a same SSB, an RO that is in the first mapping relationship and that is associated with the same SSB is used for PRACH transmission of the terminal device.

14. The method according to claim 7, wherein an RO determined based on each of the one or more PRACH configurations and an RO determined based on the basic PRACH configuration have a third mapping relationship with an SSB.

15. A wireless communication method, comprising:
transmitting, by a network device, first information to a terminal device, wherein the first information comprises one or more physical random access channel (PRACH) configurations; and
transmitting, by the network device, second information to the terminal device, wherein the second information indicates to activate a first PRACH configuration in the one or more PRACH configurations, or instruct to adjust a parameter in the first PRACH configuration.

16. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first information from a network device, wherein the first information comprises one or more physical random access channel (PRACH) configurations;
receiving second information from the network device, wherein the second information indicates to activate a first PRACH configuration in the one or more PRACH configurations, or instruct to adjust a parameter in the first PRACH configuration; and
performing at least one of the following:
activating the first PRACH configuration in the one or more PRACH configurations; or
adjusting a parameter in the first PRACH configuration.

17. The apparatus according to claim 16, wherein the parameter comprises at least one of the following:
an index of the PRACH configuration;
a period of a PRACH resource;
a subframe number corresponding to a PRACH slot;
a quantity of PRACH slots;
a quantity of random access channel occasions ROs in a PRACH slot;
an RO interval;
an RO offset; or
an offset of an index of the first PRACH configuration relative to an index of a basic PRACH configuration.

18. The apparatus according to claim 16, wherein the second information comprises one or more of following information:
an index of the first PRACH configuration;
information about a period in the first PRACH configuration;
information about an RO interval in the first PRACH configuration;
information about an RO offset in the first PRACH configuration;
indication information for increasing a period of a PRACH resource;
indication information for decreasing a period of a PRACH resource;
indication information for increasing the RO interval;
indication information for decreasing the RO interval; or
an offset of the index of the first PRACH configuration relative to an index of a basic PRACH configuration.

19. The apparatus according to claim 18, wherein the index of the first PRACH configuration is one of indexes of a plurality of PRACH configurations associated with a first preamble format, the first preamble format is a preamble format associated with the index of the basic PRACH configuration, and the indexes of the plurality of PRACH configurations associated with the first preamble format are indexes obtained after reordering.

20. The apparatus according to claim 18, wherein
the index of the first PRACH configuration is adjacent to an index of a second PRACH configuration, and the second PRACH configuration is a PRACH configuration that is activated at a previous time;
an index of a first period is adjacent to an index of a second period, the first period is the period in the first PRACH configuration, and the second period is a period in the PRACH configuration that is activated at the previous time;
the first period is 1/N1 of the second period, and N1 is a positive integer;
the first period is N2 times the second period, and N2 is a positive integer;
the first period is a result obtained after the second period is increased by a first proportion; and
the first period is a result obtained after the second period is decreased by a second proportion.
